(19) United States
(12) Patent Application Publication
(10) Pub. No.: US 2024/0332925 A1
(43) Pub. Date: Oct. 3, 2024

(54) LINE ATTACHMENT DEVICES AND METHODS FOR USE THEREOF

(71) Applicant: INFRAVISION HOLDINGS PTY LTD, New South Wales (AU)

(72) Inventors: Cameron Van Der Berg, New South Wales (AU); Daniel Van Der Berg, New South Wales (AU)

(21) Appl. No.: 18/293,188

(22) PCT Filed: Jul. 29, 2022
(86) PCT No.: PCT/AU2022/050813

§ 371 Date: Jan. 29, 2024

(30) Foreign Application Priority Data
Jul. 30, 2021 (AU) 2021902353
Aug. 3, 2021 (AU) 2021902386
Sep. 22, 2021 (AU) 2021903054
Dec. 9, 2021 (AU) 2021903983

(51) Int. Cl. H02G 1/04; B64U 10/60; B64U 101/00

(52) U.S. Cl. CPC H02G 1/04; B64U 10/60; B64U 2101/00

(57) ABSTRACT

In order to address the difficulty of quickly and safely installing power lines on transmission towers, a transmission tower line attachment device (150) is provided for facilitating installation of a line (180) on a hanging sheave (100). The line attachment device (150) comprises a first guide arm (152) and an upper frame (154) spaced from the first guide arm (152). The upper frame (154) defines a throat (156) between the first guide arm (152) and the upper frame (154). A resilient first gate (158) is arranged at an outer end of the upper frame (154) between the upper frame (154) and the first guide arm (152) and is adapted to open inwardly into the throat (156) in response to an external force and to close when the external force is removed. The line attachment device (150) is adapted to be mounted on the hanging sheave (100) at an inner end of the upper frame (154) and first guide arm (20).

### TECHNICAL FIELD

The present disclosure relates to a line attachment device and methods for use therefore for assisting with the installation of power line cables on transmission towers. In particular, the present invention relates to a device that facilitates the threading of a line onto the hanging sheave of a transmission tower.

The present disclosure further relates to a transmission tower anchoring system and method for assisting with the installation process for power line cables on transmission towers. In particular, the present invention further relates to a system, device, and method that facilitate the anchoring of a line at the end of a stringing run.

### BACKGROUND OF THE INVENTION

Stringing high voltage power lines to transmission towers is a difficult, dangerous, and time-consuming operation usually involving helicopters, cable winches, and a large work force of dozens of workers in the field, some of them very highly skilled, such as helicopter pilots and the helicopter crews.

Using helicopters in close proximity to transmission towers is inherently very dangerous as sudden wind gusts can cause accidents with catastrophic consequences. The resources required and cost to conduct such an operation are also immense due to the total number of man hours needed, the high levels of expertise required, the running costs for the helicopter and other equipment, the safety requirements, etc. Helicopters have traditionally been required to perform the power line stringing operation because of the weight of the power line cables, which require powerful aircraft to lift the cables and the ability to hover over the transmission tower while the cable is installed.

The threading of a line onto the hanging sheave is a precision operation that requires a high level of operator skill and is a time consuming to perform. The longer it takes to complete this operation on each tower, the greater the danger that an accident may occur and the higher the cost of performing the operation.

It is therefore desirable to improve the efficiency of the attachment of a line to each tower when installing high voltage power line cables on transmission towers.

Further, during the installation of high voltage power lines on transmission towers, an aerial vehicle, such as a helicopter or unmanned aerial vehicle (UAV) is used to attach a line, being either the transmission cable or a lighter weight primary line that is then replaced by a cable, to a series of consecutive transmission towers. The aerial vehicle typically draws the free end of the line from a spool or winch and threads the line onto the hanging sheave of the first transmission tower. The aerial vehicle then draws the free end of the line to the next transmission tower and threads the line onto the hanging sheave of the next transmission tower. This process is repeated in order to string the line across a series of transmission towers.

Once the line is threaded onto the hanging sheave of the final transmission tower in the series, the line then has to be anchored to a point on the ground so that the line can be tensioned. Keeping tension on the line while the end of the line is lowered to the ground and secured to a ground anchor point is difficult and can result in the line sagging in between transmission towers, which can result in entanglement in trees and other obstacles.

It is therefore also desirable to facilitate the process of anchoring the free end of the line to a ground anchor point while maintaining tension on the line.

### OBJECT OF THE INVENTION

It is an object of the present invention to substantially overcome or at least ameliorate one or more of the above disadvantages, to meet the above desire, or to provide a useful alternative to the prior art.

### SUMMARY OF THE INVENTION

In a first aspect, the present disclosure provides a transmission tower line attachment device for installing a line on a hanging sheave, the attachment mechanism comprising:
a first guide arm;
an upper frame spaced from the first guide arm and defining a throat between the first guide arm and the upper frame;
a resilient first gate arranged at an outer end of the upper frame between the upper frame and the first guide arm and adapted to open inwardly into the throat in response to an external force and to close when the external force is removed;
wherein the attachment mechanism is adapted to be mounted on the hanging sheave at an inner end of the upper frame and first guide arm.

In a preferred embodiment, the line attachment device further comprises:
a second gate arranged at an inner end of the upper frame, the second gate being adapted to open inwardly in response to an external force.

Preferably, the second gate is held closed by a frangible link.

Further preferably, the resilient first gate is spring mounted to the upper frame.

In a preferred embodiment, the line attachment device further comprises a second guide arm projecting upwardly from the upper frame.

In a second aspect, the present disclosure provides a hanging sheave for a transmission tower, the hanging sheave comprising:
an aperture for housing at least one power line;
a resilient gate providing access to the aperture and adapted to open inwardly to allow a line to be slotted into the aperture; and
a guide arm projecting outwardly and upwardly from the hanging sheave adjacent to and from the base of the resilient gate.

Preferably, the resilient gate has a convexly curved outer profile.

In a third aspect, the present disclosure provides a transmission tower anchoring system comprising:
an anchor body;
a line adapted to be installed on a series of transmission towers by an aerial vehicle, wherein the anchor body is retained on the line by a mechanical fuse.

In a preferred embodiment, the anchor body has a hole passing through the anchor body and a loop of the line is passed through the hole and the loop is attached to another point on the line by the mechanical fuse.

In a fourth aspect, the present disclosure provides a method for anchoring a line on a transmission tower, the method comprising:
attaching an anchor body to the line by way of a mechanical fuse, the anchor body being arranged between an end portion and a trailing portion of the line;
installing the trailing portion of the line on the transmission tower using an aerial vehicle;
releasing the end portion of the line from the aerial vehicle and attaching the end portion to a ground anchor point; and
applying tension to the line until the mechanical fuse breaks, releasing the anchor body from the line.

In a preferred embodiment, the anchor body has a hole through the anchor body and the step of attaching the anchor body to the line comprises passing a loop of the line through the hole and attaching the loop to another point on the line by the mechanical fuse.

Preferably, the steps of installing the line and releasing the line are performed by a drone or unmanned aerial vehicle.

Further preferably, the line is installed in an aperture above a hanging sheave of the transmission tower and the anchor body is larger than the aperture.

In a fifth aspect, the present disclosure provides a transmission tower line anchor comprising:
an anchor body having a hole, wherein the hole is sized to receive a loop of a line passed therethrough; and
a mechanical fuse adapted to secure the loop to another point on the line.

Preferably, the anchor body is substantially spherical.

Further preferably, the mechanical fuse is a cable tie.

### BRIEF DESCRIPTION OF THE DRAWINGS

A preferred embodiment of the invention will now be described by way of specific example with reference to the accompanying drawings, in which:

FIG. 1 depicts an aerial vehicle installing a line on a transmission tower;

FIG. 2 depicts an embodiment of an attachment device and hanging sheave for a transmission tower;

FIGS. 3 to 6 depict an alternative embodiment of an attachment device and hanging sheave showing different stages of the process of installing a line on the hanging sheave.

FIG. 7 depicts an anchoring system according to the present disclosure;

FIG. 8 is a cross-sectional view of the system of FIG. 7;

FIGS. 9 to 11 depict a method of anchoring a line using the anchoring system of FIG. 7;

FIG. 12 depicts a perspective view of an alternative embodiment of an attachment device and hanging sheave for a transmission tower;

FIG. 13 depicts a side view of the embodiment of FIG. 12;

FIG. 14 depicts an enlarged side view of the attachment device and hanging sheave of FIGS. 12 and 13 showing a line that is installed on the attachment device;

FIGS. 15 and 16 depict perspective views of the attachment device and hanging sheave of FIGS. 12 and 13 showing different stages of the process of anchoring a line using the anchoring system of FIG. 7; and

FIG. 17 depicts an enlarged side view of the attachment device and hanging sheave of FIGS. 12 and 13 showing a heavy line that is installed on the attachment device.

### DETAILED DESCRIPTION OF THE PREFERRED EMBODIMENTS

The present disclosure provides a transmission tower line attachment device for facilitating the installation of a line on a hanging sheave of a transmission tower. The device employs a series of guides and gates to efficiently and securely feed the line into the hanging sheave of the transmission tower.

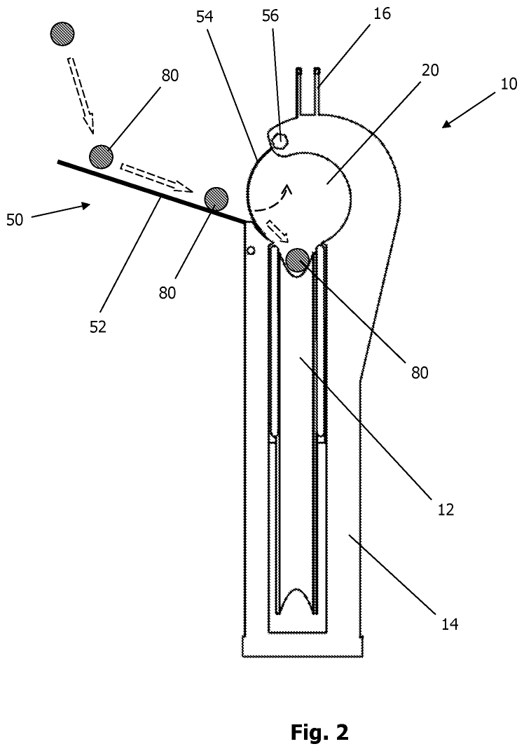

An embodiment of a hanging sheave 10 incorporating a line attachment device 50 is depicted in detail in FIG. 2. The hanging sheave 10 comprises a pulley wheel 12 mounted to a block 14 that is attached to the transmission tower by a bracket 16. A guide arm 52 projects laterally and upwardly from the block 14 near the top of the pulley wheel 12. A spring-loaded, pivotable gate 54 is mounted on the block 14 adjacent to the line guide arm 52 and provides access to an aperture 20 in the block 14 above the pulley wheel 12 by pivoting inwardly from a pivot mounting 56 at the top of the block 14. The gate 54 has a curved cross-sectional profile, curving downwardly and inwardly of the block 14.

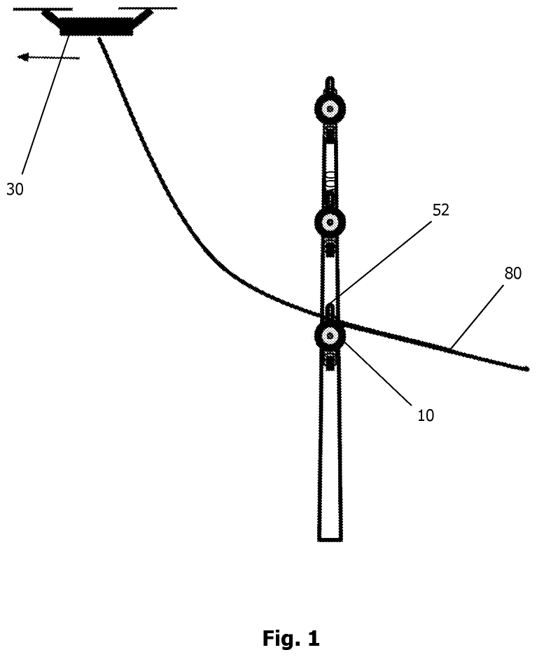

In order to slot a line 80 carried by an aerial vehicle 30 into the hanging sheave 10, the aerial vehicle 30 is operated as shown in FIG. 1 to draw the line 80 over the guide arm 52 and then to lower the line 80 onto the line guide arm 52 as shown in FIG. 2. As the aerial vehicle 30 lowers the line 80, the slope of the guide arm 52 draws the line 80 towards the gate 54, which opens by resiliently pivoting inwardly (as shown by the curved arrow in FIG. 2) and then snaps back to the closed position once the line 80 has passed into the aperture 20. The line 80 is then contained within the aperture 20 of the hanging sheave 10 on top of the pulley wheel 12. The curved profile of the gate 54 helps to prevent the line 80 from snagging on the gate 54 as it enters the aperture 20.

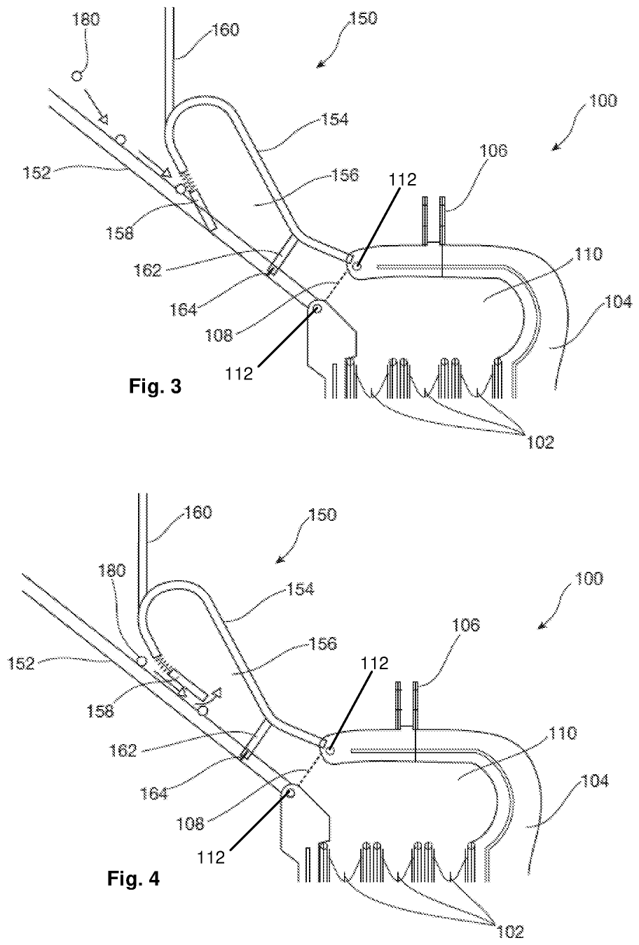

An alternative embodiment of a line attachment device 150 arranged on a traditional hanging sheave 100 is depicted in FIGS. 3 to 6. The hanging sheave 100 comprises a series of pulley wheels 102 mounted to a block 104 that is attached to the transmission tower by a bracket 106. The block 104 defines an aperture 110 above the pulley wheels 102 that is accessible via a spring-loaded sheave gate 108.

The line attachment device 150 is mounted to the hanging sheave 100 at attachment points 112 above and below the sheave gate 108. The line attachment device 150 comprises a laterally extending first guide arm 152 that projects laterally and upwardly from the block 104 near the bottom of the sheave gate 108. An upper frame 154 of the line attachment device 150 extends from the block 104 near the top of the sheave gate 108, defining an enclosed throat 156 between the upper frame 154 and the first guide arm 152.

A spring-mounted first gate 158 extends between the upper frame 154 and the first guide arm 152. In the embodiment depicted, the first gate 158 meets the first guide arm 152 at an oblique angle such that the first gate 158 can only open inwardly. It is envisaged that the first gate 158 could be embodied by many different gate mechanisms and any gate mechanism that can open inwardly due to external pressure and is prevented from opening due to internal pressure would suffice. A second guide arm 160 projects vertically from the upper frame 154 from above the first gate 158.

A second gate 162 extends between the upper frame 154 and the first guide arm 152, proximal to the sheave gate 108, and encloses the throat 156 at its lower end. In the embodiment depicted, the second gate 162 is held in the closed position, shown in FIG. 3, by a frangible link 164, such as a cable tie. It is envisaged that other frangible or force sensitive mechanisms could be used, such as spring mechanisms, to hold the second gate 162 in the closed position.

In order to slot a line 180 carried by an aerial vehicle 30 into the hanging sheave 100, the aerial vehicle 30 is operated to draw the line 180 over the guide arm 152 and then to lower the line 180 onto the guide arm 152 as shown in FIG. 3. As the aerial vehicle 30 lowers the line 180, the slope of the guide arm 152 draws the line 180 towards the first gate 158. The second guide arm 160 prevents the line 180 from being pulled over the top of the upper frame 154 and helps funnel the line 180 downwardly towards the first gate 154.

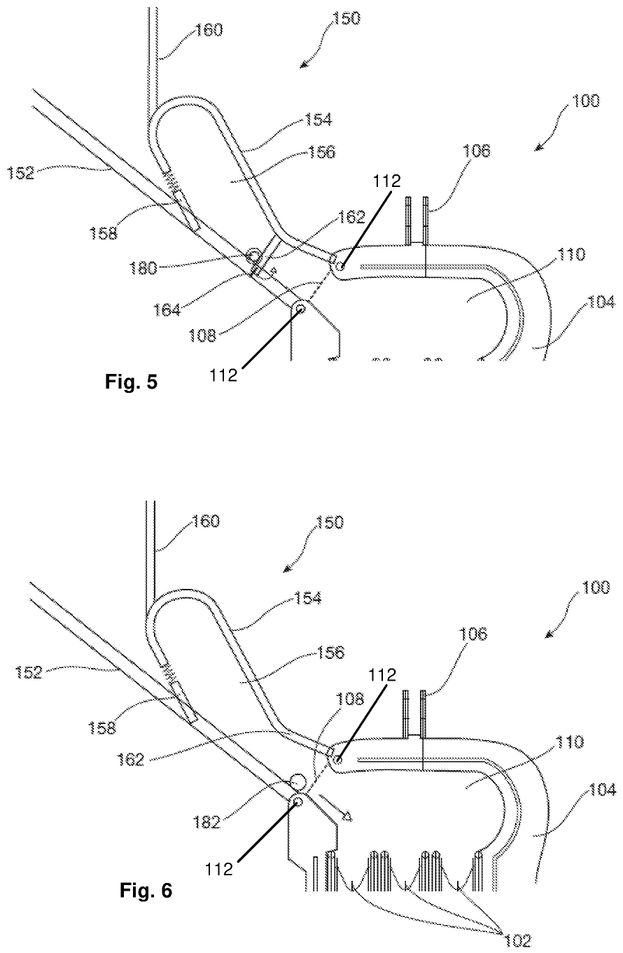

When the line 180 is drawn against the first gate 158, the first gate 158 opens by resiliently pivoting inwardly, as shown in FIG. 4, and then snaps back to the closed position once the line 180 has passed into the throat 156. The line 180 is then contained within the throat 156 and the second gate 162 is held in the closed position, keeping the line 180 contained within the throat 156, as shown in FIG. 4. With the line 180 contained within the throat, the aerial vehicle 30 can continue on and slot the line 180 into the throat 156 of the attachment device 150 on multiple successive transmission towers. Once the line 180 has been drawn through a series of transmission towers in this manner, the line 180 can then be drawn taught. This has the effect of drawing the line 180 forcefully against the second gate 162, as depicted in FIG. 5. Pressure from the tension in the line 180 as it is drawn taught is sufficient to break the frangible link 164 and allow the line 180 to pass through the second gate 162.

Further tightening of the line 180 will then draw the line 180 inwardly and downwardly through the sheave gate 108 and into the aperture 110 of the hanging sheave 100, where the line 180 can slot into one of the pulley wheels 102. During or prior to this phase, the line 180 may be used to draw a heavier gauge line 182 onto the transmission towers, in which case the original lighter line 180, acts as a pilot line that is then used to draw a heavier line 182 onto the transmission towers, as represented in FIG. 6.

The present disclosure further provides a line anchor system for temporarily anchoring a line to a transmission tower, so that the free end of the line can be secured to a ground anchor point. The line anchor system includes an anchor body that is detachable from the line by way of a mechanical fuse.

An embodiment of a line anchor system 200 is depicted in FIG. 7. The line anchor system 200 includes a line 210, an anchor body 280, and a mechanical fuse 250. The anchor body 280 has a hole 282 extending through the anchor body 280. When installed on the line 210, the anchor body 280 is secured to the line 210 by the mechanical fuse 250. The anchor body 280 is preferably formed from a lightweight plastic, such as polyethylene.

In order to secure the anchor body 280 on the line 210, a loop 212 of the line 210 is passed through the hole 282 and the loop 212 is attached to another point on the line 210, spaced from the loop 212 by an intermediate portion 214 of the line 210 that is wrapped back around the anchor body 280 to meet the loop 212. The loop 212 is attached to the intermediate portion 214 of the line 210 by the mechanical fuse 250, or other frangible link, such as a cable tie. It is envisaged that other frangible or force sensitive mechanisms could be used, such as force sensitive clamps, to retain the anchor body 280 on the line 210. This allows a predetermined load to be placed on the line 210 in order to break the mechanical fuse 250 and release the anchor body 250 from the line 210.

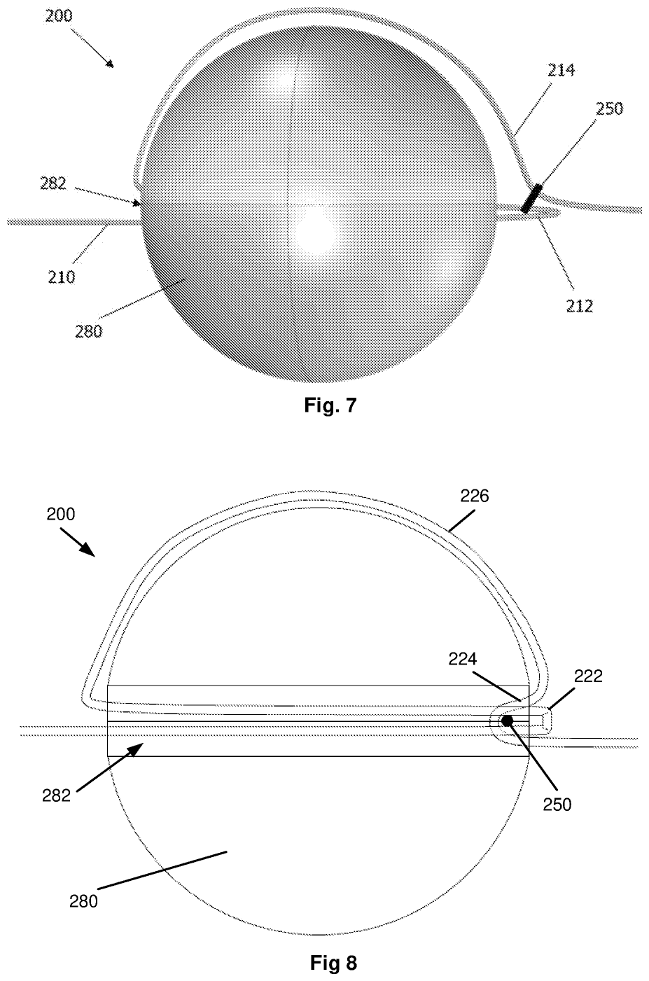

An alternative embodiment is depicted in cross-section in FIG. 8, in which the fuse 250 is located in the hole 282. In this embodiment, a first loop 222 is passed into one end of the hole 282 and a second loop 224, spaced from the first loop 222 by an intermediate portion 226, is passed into the opposite end of the hole 282. The first loop 222 and the second loop 224 meet in the hole and are linked by the mechanical fuse 250. The intermediate portion 226 passes around the outside of the anchor body 280.

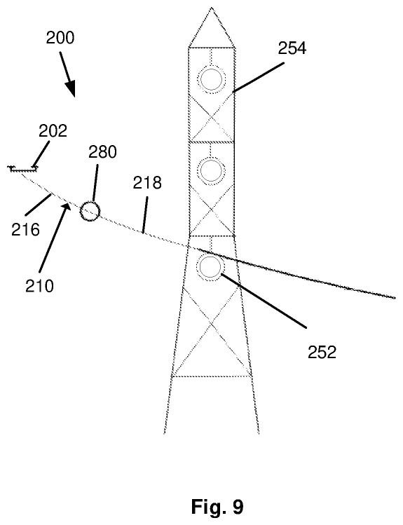

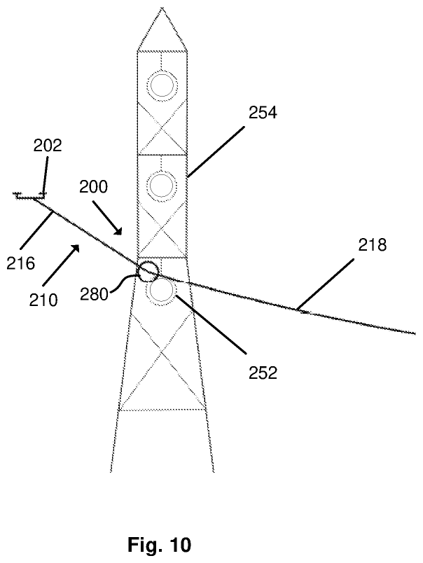

As shown in FIG. 9, the line anchor system 200 is arranged between an end portion 216 and a trailing portion 218 of the line 210. During operation, an aerial vehicle 202 carries the end portion 216 of the line 210 to a series of transmission towers 254 and threads the trailing portion 218 of the line 210 into an aperture above a hanging sheave 252 of each transmission tower 254. Once the line 210 has been threaded onto the hanging sheave 252 of the last transmission tower 254, the aerial vehicle 202 reverses toward the transmission tower 254 and the line 210 is allowed to retract until the anchor body 280 abuts against the hanging sheave 252, as shown in FIG. 10. This anchor body 280 acts as a stop and prevents further retraction of the line 210, while the end portion 216 of the line 210 falls slack.

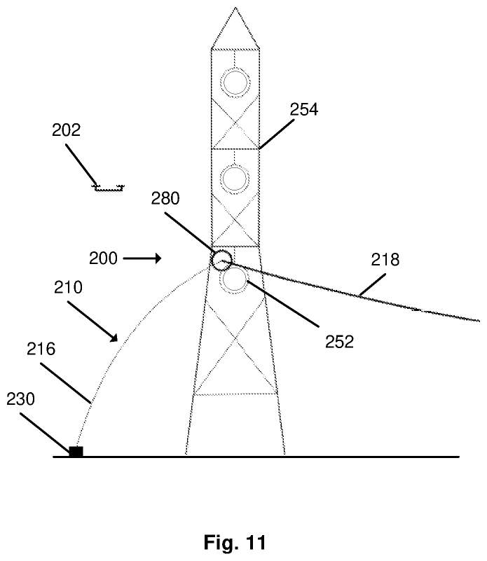

As shown in FIG. 11, the end portion 216 of the line 210 can then be dropped or lowered to the ground by the aerial vehicle 202 where it can be secured to a ground anchor point 230. The tension can then be increased on the line 210 by winding the line 210 onto a cable winch at one end. When the tension exceeds the maximum yield of the mechanical fuse 250, the mechanical fuse 250 breaks and the loop 212 is retracted from the hole 282, releasing the anchor body 280 from the line 210 and allowing it to fall to the ground. The anchor body 280 can then be collected and reused on the line installation for a subsequent series of transmission towers. With the line 210 now fully installed and taught, the transmission cable or a heavier line can be installed on the transmission towers 254 by attaching it to one end of the line 210 and winding the other end of the line 210 in, thereby pulling the transmission cable or heavier line into place on the transmission towers 254.

The anchor body 280 and anchoring system 200 of the present disclosure allows the line 210 to be quickly and easily anchored to the hanging sheave 252 of the final transmission tower 254, allowing the end portion 216 of the line 210 to be lowered to the ground and secured to a ground anchor point. The anchor body 280 can then be easily detached from the line 210 by applying tension to the line 210 and breaking the mechanical fuse 250.

As the anchor body 280 simply falls to the ground, the anchor body 280 can be easily retrieved and reused by attaching it to another line with a new mechanical fuse in the same way as described above.

The lightweight nature and spherical shape of the anchor body 280 means that it does not damage the hanging sheave 252 of the transmission tower 254 when it abuts against the hanging sheave 252 during operation.

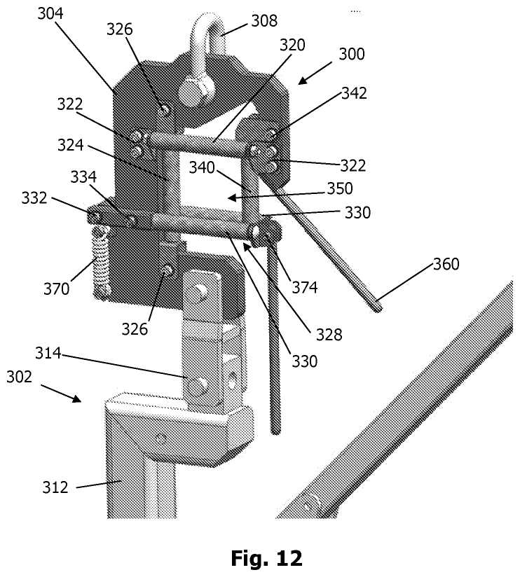

An alternative embodiment of a line attachment device 300 arranged on a hanging sheave 302 is depicted in FIGS. 12 to 17. The attachment device 300 comprises a device body 304 that is attached to a transmission tower 306 by a shackle 308. Although the illustrated embodiments show the attachment device 300 attached to an insulator, it will be appreciated that the attachment device 300 is able to be attached to other parts of the transmission tower 306 as desired or required. It is further appreciated that, in other embodiments, the attachment device 300 is attached to the transmission tower 306 by a means other than a shackle, for example a hook or clip. The line hanging sheave 302 comprises a pulley wheel 310 mounted to a block 312 that is attached to the device body 304 by a second bracket 314, whereby in use the pulley wheel 310 hangs below the attachment device 300. In other embodiments, there is a pulley wheel set in place of the pulley wheel 310, such pulley wheel set including a plurality of individual pulley wheels. In yet other embodiments, the pulley wheel 310 may be replaced with any electrical construction pulley, traveller or block that can accept an externally loaded rope or wire that sits within a safe working limit of the device.

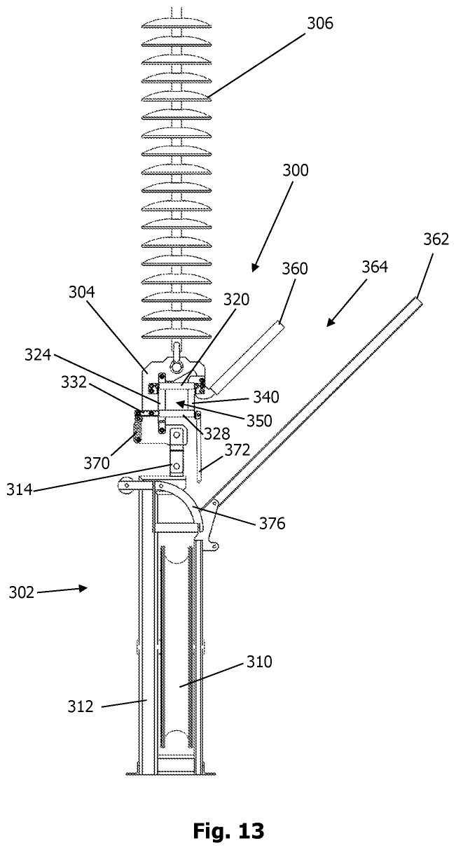

The attachment device 300 further includes: an uplift control roller 320 mounted at its ends to device body 304 at attachment points 322; a vertical roller 324 mounted at its ends to device body 304 at attachment points 326; and a pivotable roller set 328 comprising two parallel rollers 330. The roller set 328 is attached at one end to a roller bracket 332 that is in turn pivotably mounted to the device body 304 at a pivotable attachment point 334. The attachment device 300 further includes a light weight roller gate 340 pivotably mounted to the device body 304 at a pivotable attachment point 342 that is resiliently biased into a closed position as shown in FIGS. 12 and 13. The closed position is such that the distal end of the roller gate 340 hangs within an absence between parallel rollers 330. It will be appreciated that the uplift control roller 320, the vertical roller 324, the roller set 328 and the roller gate 340 collectively define an aperture 350 that is accessible via the roller gate 340.

In other embodiments, there will be a single roller in place of the pivotable roller set 328. Further, where a single roller is used in the illustrated embodiments, other embodiments use two or more rollers. In yet further embodiments, in place of the rollers of the illustrated embodiments are non-moveable components that are low friction.

It will be appreciated that the terms “horizontal” and “vertical” in relation to components are used as descriptors and that the attachment device 300 may hang from the transmission line 306 such that the actual orientation of those “horizontal” and “vertical” components are not necessarily horizontal and vertical.

The attachment device 300 comprises a laterally extending first guide arm 360 that is integrally formed with the device body 304 that projects laterally and upwardly from the device body 304 near pivotable attachment point 334. It will be appreciated that in other embodiments, the first guide arm 360 is not integrally formed with the device body 304 but is a separate component attached to the device body 304. The block 312 includes a laterally extending second guide arm 362 that projects laterally and upwardly from the block 312 near the top of the pulley wheel 310. It will be appreciated that the first guide arm 360 and the second guide arm 362 collectively define a guide channel 364 for receiving a line.

The roller bracket 332 is also attached to a coil spring 370 that is in turn attached to the device body 304 such that the roller set 328 is resiliently biased into a horizontal position as show in FIGS. 12 to 14. In other embodiments, the roller bracket 332 is further attached to a second coil spring that is attached in a similar fashion to the device body 304 but positioned on the other side of the device body 304 parallel to the coil spring 370 to add additional resilient bias. The roller set 328 is pivotably attached at another end (that is, the end that is not attached to the roller bracket 332) to a third guide arm 372 at a pivotable attachment point 374 such that the third guide arm 372 hangs vertically from the attachment point 374.

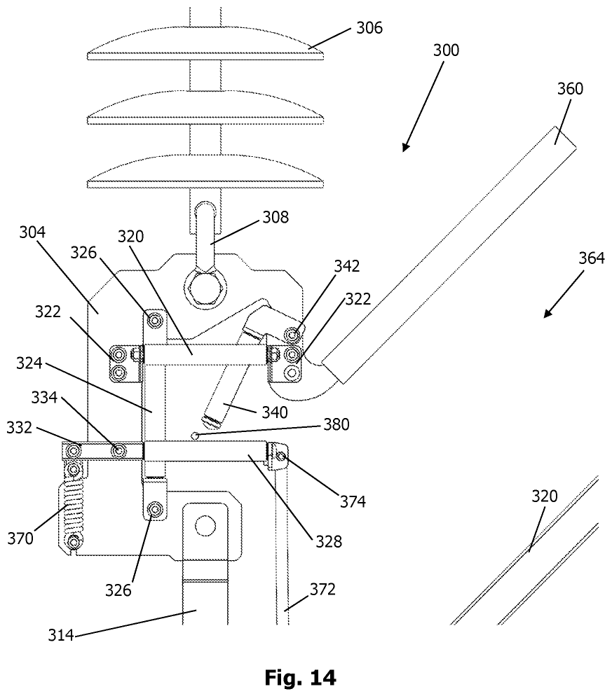

In order to slot a pilot line 380 carried by an aerial vehicle (such as aerial vehicle 30 from FIG. 1 or aerial vehicle 202 from FIGS. 9 to 11) into the hanging sheave 302, the aerial vehicle is operated to draw the line 180 into the guide channel 364 between the first and second guide arms 360 and 362. Once the line 180 is immediately horizontally adjacent to the roller gate 340 the aerial vehicle is operated to draw the line 180 towards the aperture 350 into the roller gate 340 such that upon contact, the pilot line 380 forces the roller gate 340 to rotate open by pivoting about the pivotable attachment point 342, as shown in FIG. 14, thereby allowing the pilot line 380 to be positioned within the aperture 350. Once the pilot line 380 ceases contact with the roller gate 340, the roller gate 340 moves back to the closed position.

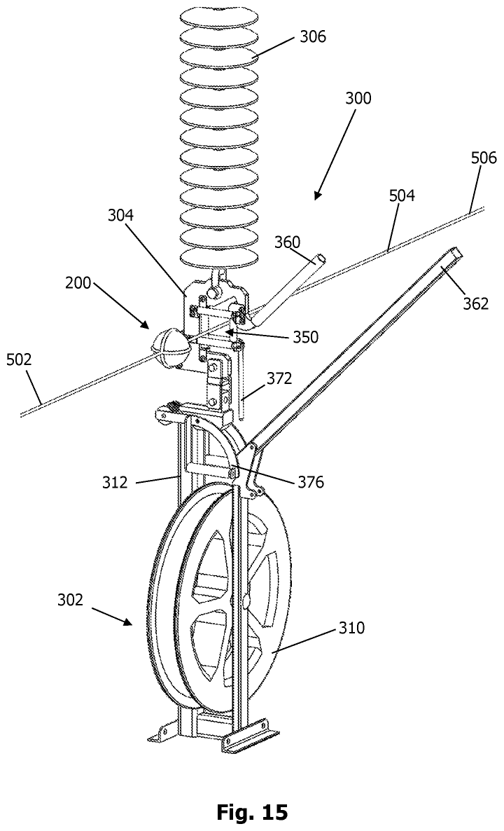

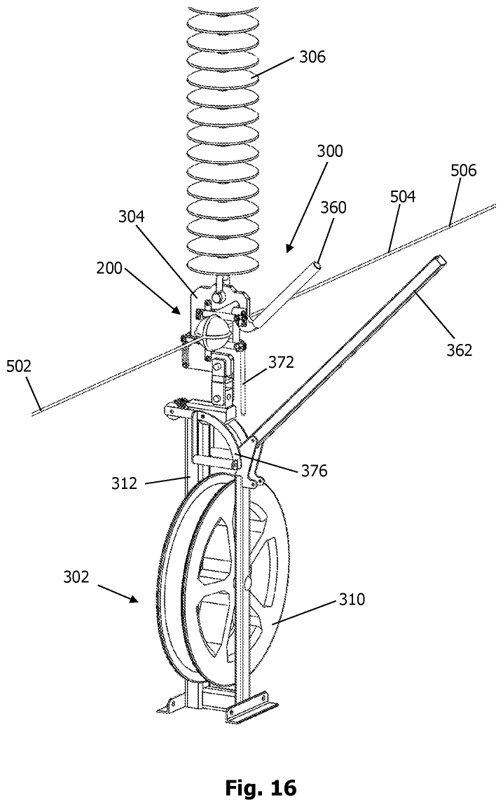

Referring now to FIGS. 15 and 16, the line attachment device 300 is shown in combination with the line anchor systems 200 of FIGS. 7 and 8.

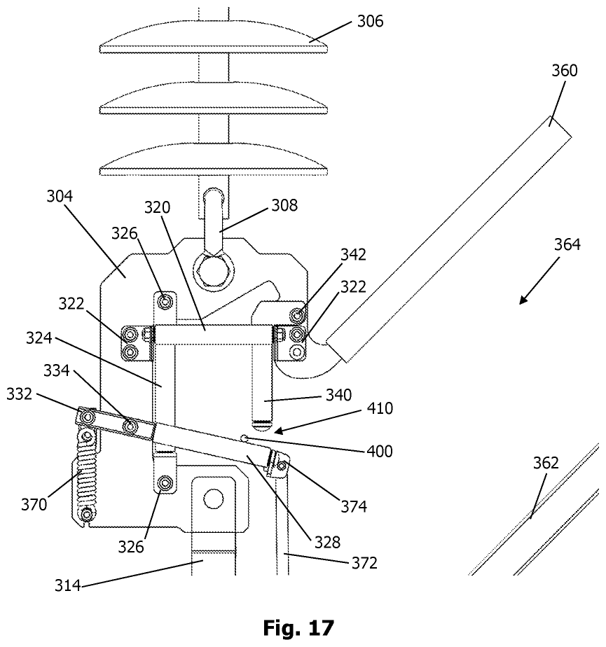

As shown in FIG. 16, the line anchor system 200 is arranged between an end portion 502 and a trailing portion 504 of a line 506. During operation, an aerial vehicle (such as aerial vehicle 30 from FIG. 1 or aerial vehicle 202 from FIGS. 9 to 11) carries the end portion 502 of the line 506 to a series of transmission towers (such as transmission tower 306) and threads the trailing portion 504 of the line 506 into the aperture 350 of the attachment device 300 attached to each tower. Once the line 506 has been threaded onto the attachment device 300 of the last of the series of transmission towers, the aerial vehicle reverses toward the last transmission tower and the line 506 is allowed to retract until the anchor body 280 abuts against at least two of (but potentially all four of) the uplift control roller 320, the vertical roller 324, the roller set 328 and the roller gate 340, as shown in FIG. 17. This anchor body 280 acts as a stop and prevents further retraction of the line 506, while the end portion 502 of the line 506 falls slack.

As with the embodiments described above in relation to FIGS. 9 to 11, in particular FIG. 11, the end portion 502 of the line 506 can then be dropped or lowered to the ground by the aerial vehicle where it can be secured to a ground anchor point (such as point 230 in FIG. 11). The tension can then be increased on the line 506 by winding the line 506 onto a cable winch at one end. When the tension exceeds the maximum yield of the mechanical fuse 250, the mechanical fuse 250 breaks and the loop 212 is retracted from the hole 282, releasing the anchor body 280 from the line 506 and allowing it to fall to the ground.

With the pilot line 380 now within the aperture 350 and fully installed and taught, the transmission cable or a heavier line 400 can be installed on the transmission towers 306 by attaching it to one end of the pilot line 380 and winding the other end of the pilot line 380 in, thereby pulling the transmission cable or heavier line into place on the transmission towers 306. The heavy line 400 may be a steel line 400. It is appreciated that the pilot lines are synthetic material.

The heavier weight of the transmission cable or a heavier line 400 is such that a downward gravitational force from the transmission cable or a heavier line 400 will be exerted to cause the roller set 328 to rotate against the resilient bias of the spring 370 to the configuration shown in FIG. 17. This allows the transmission cable or a heavier line 400 to move down the now sloped configuration of the roller set 328 through a gap 410 that is created by way of the downward gravitational force from the steel line 180 and drop vertically down past the third guide arm 372 through a pulley wheel gate 376 onto the pulley wheel 310. Whilst embodiments illustrated herein show the hanging sheave 302 disposed directly below the attachment device 300, it will be appreciated that in other embodiments, the hanging sheave 302 is disposed other than directly below the attachment device 300. For example, in another embodiment, the hanging sheave 302 is disposed laterally adjacent the attachment device 300.

It will be appreciated that the pulley wheel gate 376 will be configured based on the specific steel line 180 that is used. In other words, any steel cable used activates the pulley wheel gate 376 as this gate will be set to activate based on the weight of the steel line 180. In other embodiments, a frangible link or mechanical fuse arrangement is used in place of the pulley wheel gate 376 such that the steel line 180 dropping onto the frangible link or mechanical fuse will break allowing the steel line 180 to in turn drop onto the pulley wheel 310.

The embodiments illustrated in FIGS. 12 to 17 are particularly advantageous for the following reasons:
The attachment device can be retrofitted between a transmission tower and a standard hanging sheave.
The use of a “full rolling cage” in that each of the uplift control roller 320, the vertical roller 324, the roller set 328 and the roller gate 340 that collectively define the aperture 350 within which a line is fed are actually rollers. This allows a light weight line into the aperture 350 and a heavy gravitational force of a heavy line to let it out.

Although the invention has been described with reference to specific examples, it will be appreciated by those skilled in the art that the invention may be embodied in many other forms.

1. A transmission tower line attachment device for installing a line on a hanging sheave, the attachment mechanism comprising:
a first guide arm;
an upper frame spaced from the first guide arm and defining a throat between the first guide arm and the upper frame;
a resilient first gate arranged at an outer end of the upper frame between the upper frame and the first guide arm and adapted to open inwardly into the throat in response to an external force and to close when the external force is removed;
wherein the attachment mechanism is adapted to be mounted on the hanging sheave at an inner end of the upper frame and first guide arm.

2. The line attachment device of claim 1, further comprising:
a second gate arranged at an inner end of the upper frame, the second gate being adapted to open inwardly in response to an external force.

3. The line attachment device of claim 2, wherein the second gate is held closed by a frangible link.

4. The line attachment device of claim 1, wherein the resilient first gate is spring mounted to the upper frame.

5. The line attachment device of claim 1, further comprising a second guide arm projecting upwardly from the upper frame.

6. A hanging sheave for a transmission tower, the hanging sheave comprising:
an aperture for housing at least one power line;
a resilient gate providing access to the aperture and adapted to open inwardly to allow a line to be slotted into the aperture; and
a guide arm projecting outwardly and upwardly from the hanging sheave adjacent to and from the base of the resilient gate.

7. The hanging sheave of claim 6, wherein the resilient gate has a convexly curved outer profile.

8. A transmission tower anchoring system comprising:
an anchor body;
a line adapted to be installed on a series of transmission towers by an aerial vehicle, wherein the anchor body is retained on the line by a mechanical fuse.

9. The anchoring system of claim 8 wherein:
the anchor body has a hole passing through the anchor body; and
a loop of the line is passed through the hole and the loop is attached to another point on the line by the mechanical fuse.

10. The anchoring system of claim 8, wherein the anchor body is substantially spherical.

11. The anchoring system of claim 8, wherein the mechanical fuse is a cable tie.

12. A method for anchoring a line on a transmission tower, the method comprising:
attaching an anchor body to the line by way of a mechanical fuse, the anchor body being arranged between an end portion and a trailing portion of the line;
installing the trailing portion of the line on the transmission tower using an aerial vehicle;
releasing the end portion of the line from the aerial vehicle and attaching the end portion to a ground anchor point; and
applying tension to the line until the mechanical fuse breaks, releasing the anchor body from the line.

13. The method of claim 12 wherein the anchor body has a hole through the anchor body and the step of attaching the anchor body to the line comprises passing a loop of the line through the hole and attaching the loop to another point on the line by the mechanical fuse.

14. The method of claim 12, wherein the steps of installing the line and releasing the line are performed by a drone or unmanned aerial vehicle.

15. The method of claim 12, wherein the anchor body is substantially spherical.

16. The method of claim 12, wherein the mechanical fuse is a cable tie.

17. The method of claim 12, wherein the line is installed in an aperture above a hanging sheave of the transmission tower and wherein the anchor body is larger than the aperture.

18. A transmission tower line anchor comprising:
an anchor body having a hole, wherein the hole is sized to receive a loop of a line passed therethrough; and
a mechanical fuse adapted to secure the loop to another point on the line.

19. The line anchor of claim 18, wherein the anchor body is substantially spherical.

20. The line anchor of claim 18, wherein the mechanical fuse is a cable tie.
